(19) United States
(12) Patent Application Publication
(10) Pub. No.: US 2015/0381738 A1
(43) Pub. Date: Dec. 31, 2015

(54) MEASUREMENT DATA PROVIDING SERVICE SYSTEM

(71) Applicant: FUJI ELECTRIC CO., LTD., Kawasaki-shi (JP)

(72) Inventors: Naomi AZUMA, Uenohara (JP); Shiro KONDO, Hachioji (JP)

(73) Assignee: FUJI ELECTRIC CO., LTD., Kawasaki-shi (JP)

(21) Appl. No.: 14/848,154

(22) Filed: Sep. 8, 2015

Related U.S. Application Data
(63) Continuation of application No. PCT/JP2014/054130, filed on Feb. 21, 2014.

(51) Int. Cl. H04L 29/08; G06F 21/31

(52) U.S. Cl. CPC H04L 67/12; G06F 21/31

(57) ABSTRACT

Measurement data (raw data) transmitted via a network is received by a sensor data obtainment unit, a sensor ID is extracted from the received data and is provided to an ID data detection unit, the ID data detection unit provides detected ID data to an ID retrieval unit, and the ID retrieval unit retrieves an ID table and extracts a company name and a sensor type by using the sensor ID as a key. A calculation expression file and a parameter file are referred to on the basis of the extracted company name and sensor type, data obtained by referencing is provided to a data processing unit and/or a data correction unit, and the received measurement data is corrected to significant measurement data. A process result is provided to an external user from a signal processing unit via a measured value file.

### CROSS REFERENCE TO RELATED APPLICATION

This application is a continuation of the PCTapplication PCT/JP2014/054130 which was filed on Feb. 21, 2014.

### TECHNICAL FIELD

The present invention relates to a technology that enables a physical quantity sensed by a sensor to be provided to an external user by performing signal processing on the sensed physical quantity by using a central measurement data providing service device, and by performing processing for correcting the sensed physical quantity to measurement data that is significant in the industrial field.

### BACKGROUND ART

FIG. 1 illustrates a configuration of a common sensor data collection system. In the sensor data collection system illustrated in FIG. 1, various sensors 800 are provided at the site, processing devices storing a signal processing program (e.g., a Micro-Computer) are provided for measurement data sensed by the various sensors 800, the processing devices perform signal processing on the measurement data, and the measurement data is converted into a standard signal, and is output to the outside. In FIG. 1, examples of the various sensors include a pressure sensor, a differential pressure sensor, a thermal sensor, a current sensor, and a contact-signal sensor, but the various sensors are not limited to these sensors.

The measurement data that has been converted into the standard signal as described above is aggregated in an RTU (Remote Terminal Unit) or PLC (Programmable Logic Controller) 700. The RTU/PLC 700 is connected to a network (including a cellular network) 500 via a modem 600, and is connected to a server 400 on a data-collection side via the network 500. The server 400 serves as a central unit that collects data of the various sensors 800 provided at the site. In the server 400, software for customers 410 and general-purpose SCADA (Supervisory Control And Data Acquisition) software 420 have been prepared such that the server 400 can correspond to customers and sensors.

In the conventional sensor data collection system described above, the various sensors 800 provided at the site need a power source, communication wiring, or the like, and there is a problem wherein installation work at the site requires much time and labor.

Because signal processing is performed in the various sensors 800 and the PLC 700, a load is applied to a CPU (Central Processing Unit) or the like, and there is a problem wherein a large power is consumed.

Further, all of the signal processing programs have been installed on the above various sensors 800, and therefore in updating of the programs, a worker needs to visit the site and replace the programs.

As described above, when sensors are added to or relocated in the conventional sensor data collection system, software in a high-order PLC or SCADA in addition to the sensors needs to be changed at the site, and there is a problem wherein engineering man-hours are required.

Meanwhile, Patent Document 1 listed below discloses a data collection device that is capable of collecting data from a CPU unit of a PLC at high speed without fail. However, the data collection device disclosed in Patent Document 1 is a data collection device that performs real-time processing for collecting IO data of the CPU unit and time-sharing processing for storing collected data in a large-capacity storage unit provided in the data collection device. Therefore, Patent Document 1 does not describe that measurement data is provided to an external user after performing data processing or data correction that is suitable for the external user on the measurement data.

Patent Document 2 listed below discloses that, in a system for providing service information for maintaining site systems that each include pieces of equipment installed at the site and control terminals that control or monitor the pieces of equipment, a computer system is connected to terminals installed at a design information providing destination of the site systems and terminals installed at a maintenance inspection information providing destination that performs maintenance and inspection of the pieces of equipment or the control terminals of the site systems via networks, and includes databases in which information relating to the site systems is stored from the terminals, and a maintenance server that authenticates access permission/non-permission to the databases and that also performs charge processing on a user of a terminal to which access permission is given. However, the computer system disclosed in Patent Document 2 relates to inspection and maintenance of pieces of equipment installed at the site, and control terminals that control or monitor the pieces of equipment, and does not describe that measurement data is provided to an external user after performing data processing or data correction that is suitable to the external user on the measurement data.

Patent Document 3 listed below discloses a device for collecting measurement data for the site that includes a sensor block for site measurement that converts a physical quantity to be measured into digital measurement data and outputs the digital measurement data, and a processing block that performs processing for storing the digital measurement data output from the sensor block in accordance with a previously set program. However, the device for collecting measurement data for the site disclosed in Patent Document 3 merely simplifies the sensor block for site measurement, collects the measurement data in the processing block, processes the collected measurement data in the processing block, and stores the processed measurement data in a detachable external memory, or transfers data to an external personal computer via a communication unit and processes the measurement data. Therefore, the device for collecting measurement data for the site disclosed in Patent Document 3 does not describe that measurement data is provided to an external user after performing data processing or data correction that is suitable to the external user on the measurement data.
Patent Document 1: Japanese Laid-open Patent Publication No. 2004-199670
Patent Document 2: Japanese Laid-open Patent Publication No. 2002-334167
Patent Document 3: Japanese Laid-open Patent Publication No. 05-174159

### DISCLOSURE OF THE INVENTION

In order to solve the problems above, an object of the present invention is to provide a measurement data providing service system in which sensors provided at the site are assigned IDs for respective companies and respective types, the sensors sense a physical quantity and output an analog value to a next-stage conversion communication unit, the conversion communication unit converts the analog value into a digital value and transmits measured raw data to a collection destination via a network, and the collection destination performs signal processing on the raw data so as to convert the raw data into significant measurement data and provides the signification measurement data to an external user.

In order to attain the above object, according to the first invention, a measurement data providing service system is provided in which sensors are provided at the site, the sensors being assigned IDs for respective companies and respective types or being assigned sequentially numbered IDs and forming a set with a table that identifies the respective companies and the respective types, a physical quantity to be measured is sensed by the sensor and is converted into a digital value, the converted digital value is transmitted as raw data via a network to a central measurement data providing service device, the measurement data providing service device performs signal processing on the raw data so as to be a significant measurement data value, and the significant measurement data value is provided to a user,

wherein the measurement data providing service device includes:
an ID data table that stores company names and type names that correspond to the IDs assigned to the sensors;
an ID retrieval unit that reads a prescribed ID from the ID data table, accesses the sensor associated with the ID via the network, and collects measurement data;
a signal processing unit that reads the ID from the measurement data transmitted from the sensor, searches the ID data table via the ID retrieval unit by using the read ID as a key, reads a parameter and a calculation expression associated with the ID from a parameter file and a calculation expression file, and performs signal processing;
a measured value file that stores measurement data significant in an industrial field, the measurement data being obtained by performing signal processing; and
a service providing unit that provides, to an external user, the measurement data significant in the industrial field, the measurement data being stored in the measured value file.

According to the second invention, in the first invention, further comprising:

a relay unit that relays the raw data to the network, wherein

the relay unit includes:
a plurality of wireless reception units that each wirelessly receive the sensed raw data that has been converted into the digital value, a concentrator that aggregates and outputs data of the plurality of wireless reception units, and a portable communication module that receives the data output from the concentrator, and transmits the data to the network.

According to the third invention, in the first invention, the signal processing unit performs at least one process or more of range conversion, range weighting, linearization, and compensation on the basis of content stored in the parameter file and the calculation expression file so as to conform to a specification of the external user.

According to the fourth invention, in the third invention, the signal processing unit is provided so as to correspond to each of the companies.

According to the fifth invention, in the fourth invention, the signal processing unit collectively performs signal processing on pieces of measurement raw data from sensors of the same company having different IDs.

According to the sixth invention, in any one of the first to third inventions, the parameters associated with the IDs are provided in the parameter file so as to correspond to the respective companies and the respective types, or so as to have the sequentially numbered IDs and to correspond to the respective companies and the respective types by using the table.

According to the seventh invention, in any one of the first to sixth inventions, the ID assigned to the sensor is configured of a serial number.

According to the eighth invention, in the third invention, the compensation in the signal processing unit performs correction to significant measured value data that conforms to a specification of the user's company by performing compensation for a change in temperature.

According to the ninth invention, in the third invention, the range weighing in the signal processing unit performs data correction so as to obtain a range that conforms to a specification of the user's company by changing weighing of the range.

According to the tenth invention, in the third invention, the linearization in the signal processing unit performs correction to measurement data having a linear characteristic by linearizing measurement data having a non-linear characteristic so as to obtain significant measured value data that conforms to a specification of the user's company.

According to the eleventh invention, in the first invention, the measurement data providing service device includes an analysis unit that receives data processed by the signal processing unit, and that performs data analysis and diagnosis.

According to the twelfth invention, in the first invention or the eleventh invention, the service providing unit includes an authentication mechanism that confirms genuineness of the external user, and provides the measurement data and/or analysis data significant in the industrial field to the external user for which the genuineness has been confirmed.

According to the present invention, complicated tasks such as installation, addition, or moving of measurement points, and simultaneity in changing of software are not required, and therefore engineering man-hours can be significantly reduced. In other words, the present invention does not require a data editing function, such as a general-purpose SCADA or a PLC, that is essential for a conventional configuration.

Further, according to the present invention, a measurement data providing service device on a central device side can access a plurality of sensors assigned IDs for respective companies and respective types on the basis of sensor IDs, and an external user can obtain measurement data that conforms to a company specification merely by having registered a profile and a calculation expression relating to a sensor that conforms to the company specification in the measurement data providing service device.

Furthermore, according to the present invention, the measurement data providing service device performs signal processing so as to correct measurement data to a significant value. Therefore, a low-cost sensor that does not need soft matter can be provided at the site, and a workload relating to the construction of a measurement system can be significantly reduced.

### BRIEF DESCRIPTION OF THE DRAWINGS

FIG. 1 illustrates a configuration of a common sensor data collection system.

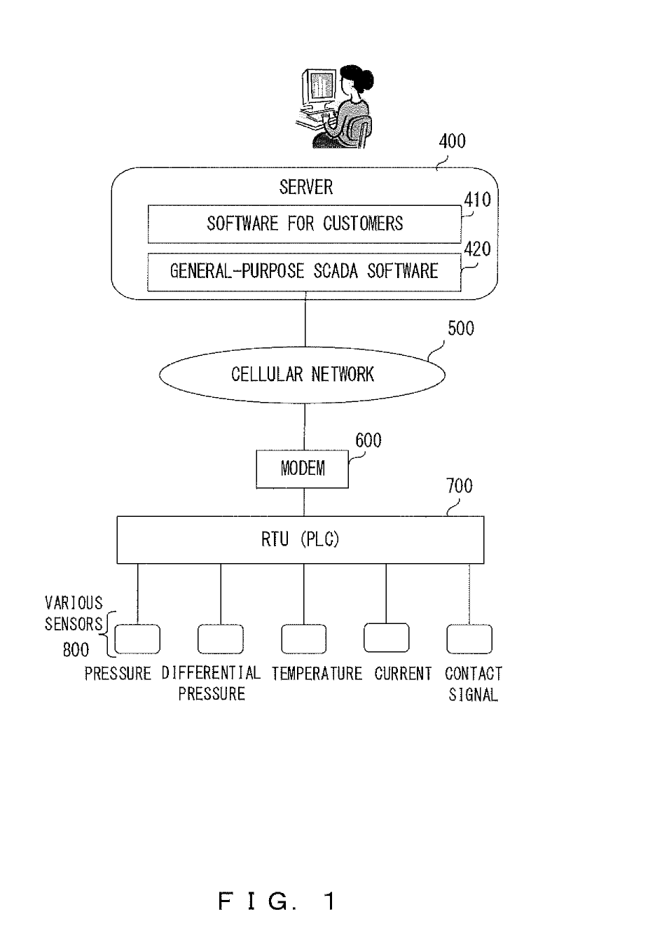

FIG. 2 illustrates a configuration of a measurement data providing service system according to an embodiment of the present invention.

FIG. 3 illustrates a processing flow for each functional block of a measurement data providing service system according to the embodiment of the present invention.

FIG. 4 illustrates content of respective components in a measurement data providing service device according to the embodiment of the present invention.

FIG. 5 illustrates a relationship among respective components in a measurement data providing service device according to the embodiment of the present invention.

FIG. 6 is a diagram explaining linearization in a data correction unit of a signal processing unit according to the present invention.

### DESCRIPTION OF THE PREFERRED EMBODIMENTS

An embodiment of the present invention is described below with reference to the drawings.

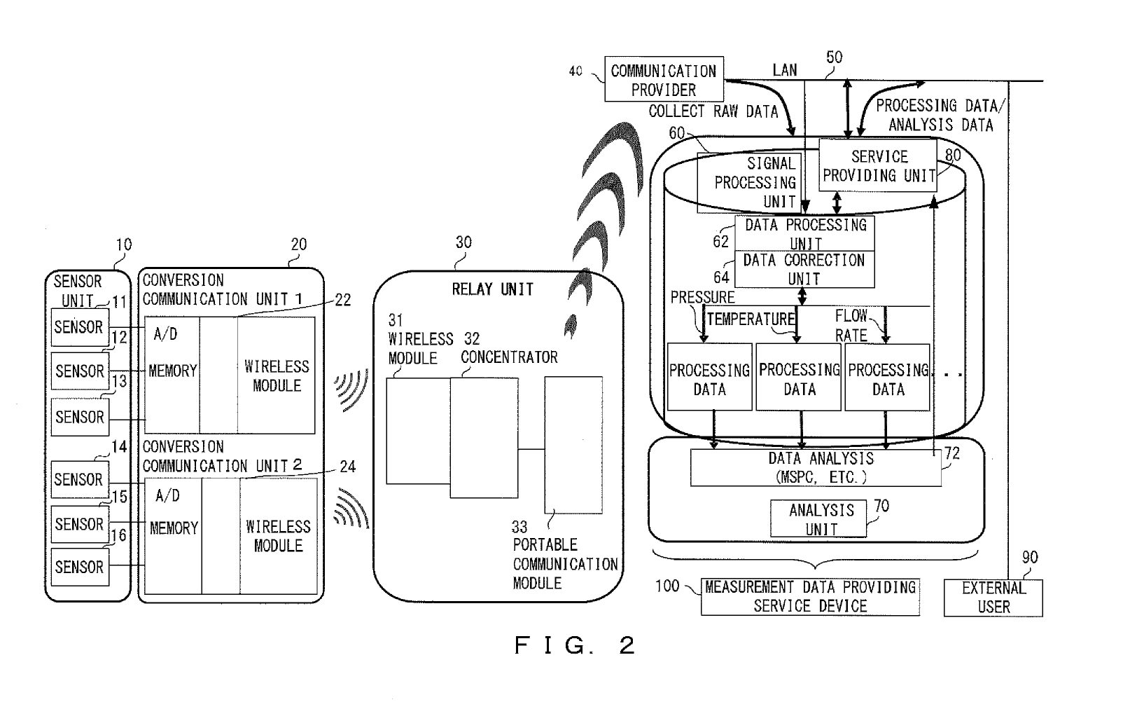

FIG. 2 illustrates a configuration of a measurement data providing service system according to an embodiment of the present invention. In FIG. 2, the measurement data providing service system according to the embodiment of the present invention is configured so as to be divided into respective functional blocks of a sensor unit 10, a conversion communication unit 20 (a conversion communication unit 1 and a conversion communication unit 2), a relay unit 30, a communication provider (network) 40, a LAN 50, a signal processing unit 60, an analysis unit 70, and a service providing unit 80. The signal processing unit 60, the analysis unit 70, and the service providing unit 80 configure a measurement data providing service device 100 as the center of the present invention. The measurement data providing service device 100 is described later in detail.

In FIG. 2, the sensor unit 10 includes a plurality of sensors 11-16 that respectively measure, for example, pressure, temperature, or a flow rate. In the measurement data providing service system, the sensors 11-16 are assigned sensor IDs for respective companies and respective types, and the sensors 11-16 transmit sensed raw values (raw data), namely, analog signals, to the conversion communication unit 20 (the conversion communication unit 1 and the conversion communication unit 2) without performing correction processing on measured values. Specifically, physical quantities are sensed by pickups of the sensors 11-16, correction processing is not performed on the sensed data values (raw data), and analog signals as sensed are transmitted to the conversion communication unit 1 (22) and the conversion communication unit 2 (24). Therefore, a size of sensor equipment can be minimized, and the sensor equipment does not need to include a function of performing correction at the site, or other functions that conventional sensors include. This leads to miniaturization, weight reduction, and economization.

The conversion communication unit 20 (the conversion communication unit 1 and the conversion communication unit 2) includes memories that individually store sensor IDs for respective companies and respective types which have been assigned to the sensors 11-16, A/D (Analog-Digital) converters that convert analog signals from the sensors 11-16 into digital signals, and time data addition units, which are not illustrated. Time data is generated by affixing a time stamp at a point in time at which an analog signal is converted into a digital signal. The conversion communication unit 20 further includes wireless modules that wirelessly transmit the digital signals of the sensors 11-16 from the conversion communication unit 20 to the relay unit 30. The wireless modules of the conversion communication unit 20 maybe installed with a portable communication module that is directly connected to a communication provider. In this case, the wireless modules can wirelessly transmit digitalized measurement data to the network 40 provided by the communication provider without going through the relay unit 30 in a rear stage (although this is not illustrated).

The relay unit 30 receives data that has been wirelessly transmitted from the conversion communication unit 1 (22) and the conversion communication unit 2 (24) by means of a wireless module 31, and transmits the data received by the wireless module 31 to the communication provider network 40 via a portable communication module 33 and a wireless base station (not illustrated). This system includes a concentrator 32 of the relay unit 30 that aggregates data from a plurality of conversion communication units 20 (the conversion communication unit 1 and the conversion communication unit 2), and this allows the number of portable communication modules to decrease, compared with a case in which portable communication modules (not illustrated) are respectively provided for the conversion communication units 22 and 24. Thus, a cost relating to communication can be reduced.

The signal processing unit 60 stores measurement data (raw data) and time data that have been transmitted via the network 40 provided by the communication provider and the LAN (Local Area Network) 50 in a memory (not illustrated) by using an ID assigned to the measurement data as a key. In the signal processing unit 60, various tables described later have been prepared that store a specification unique to a customer, such as a company name (customer name), a sensor type, correction data, or a calculation expression, on the basis of ID data.

Calculation processing conforming to the specification of the customer is performed by using the correction data and the calculation expression stored in the signal processing unit 60 for each ID, correction processing is performed so as to obtain data that is significant in the industrial field, and the obtained data is stored for the customer. The signal processing unit 60 stores data so as to provide measurement data or calculation processing data from a sensor that has been assigned an ID that is only associated with a company (customer) authenticated by a known authentication mechanism (not illustrated) in the service providing unit 80, in accordance with a request from the customer. This is because confidentiality is secured in the measurement data providing service device 100 in order to secure measured data against leaking to a spoofing third part such that the genuineness of measurement data to be provided to an external user 90 can be ensured.

The analysis unit 70 calculates an index that clearly indicates a correlation among pieces of calculation processing data that have been stored in the memory (not illustrated) in the signal processing unit 60, as described above, or performs data analysis 72 on the pieces of calculation processing data, for example, with the Multivariate Statistical Process Control (MSPC) so as to obtain the life of a plant or a device, and provides an analysis result to an external user 90 who desires to be provided with the analysis result.

The service providing unit 80 identifies a request for the measurement data that has been issued from the external user 90, via the known authentication mechanism (not illustrated), and provides processing data of the signal processing unit 60 and/or analysis data of the analysis unit 70 to the external user 90 in accordance with a contract with the external user 90.

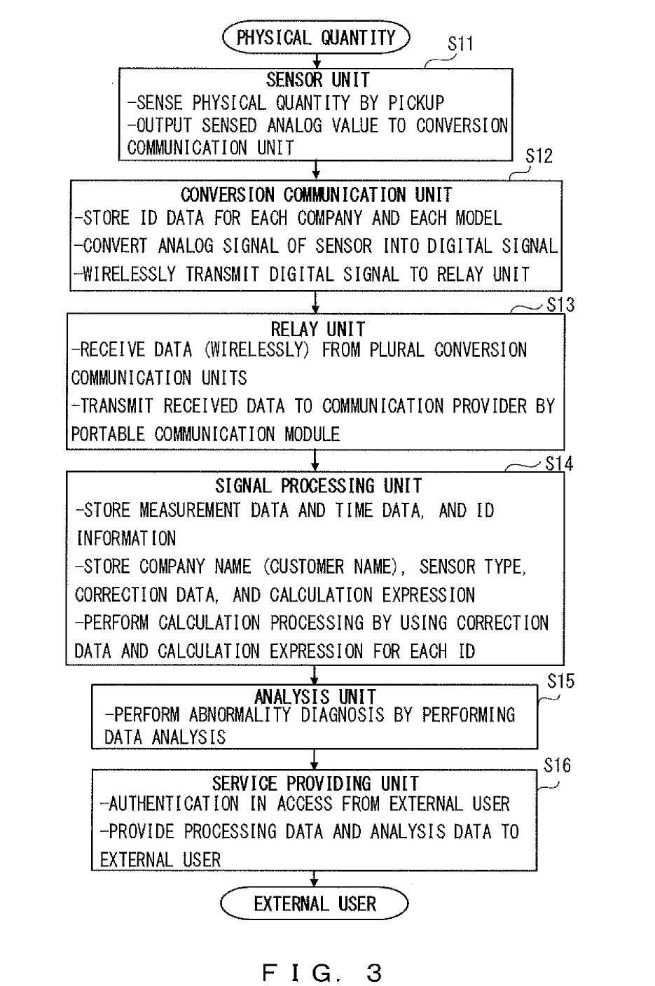

FIG. 3 illustrates a flow explaining operations of functional blocks configuring a measurement data providing service system according to the embodiment of the present invention. With reference to FIG. 3, operations of respective functional blocks are sequentially described. First, in step S11, the sensor unit 10, which includes sensors that measure, as an example, pressure, temperature, or a flow rate, does not perform correction processing on values that have been measured by means of the sensors at the site, and outputs the values to the conversion communication unit 20 as analog signals, as described above with reference to FIG. 2.

In step S12, the conversion communication unit 20 individually stores, in the memory, sensor IDs assigned for respective companies and respective types, converts the analog signals of the sensors into digital signals by using the A/D converters, and adds a point in time at which sensing is performed to data. Then, the wireless modules of the conversion communication unit 20 wirelessly output the digital signals of the sensors to the relay unit 30.

In step S13, the relay unit 30 receives data from the plurality of conversion communication units 22 and 24 by means of the wireless module 31, and transmits the data received by the wireless module 31 to the communication provider network 40 via the portable communication module 33 and the wireless base station (not illustrated).

In step S14, the signal processing unit 60 stores, in a memory (not illustrated) of the signal processing unit 60, measurement data (raw data) and time data that have been transmitted via the network 40 provided by the communication provider and the LAN 50, by using an ID assigned to the measurement data as a key. Calculation processing conforming to a specification of a customer is performed by using correction data and a calculation expression (described later) that have been prepared in the signal processing unit 60 for each ID, correction processing is performed so as to obtain data that is significant in the industrial field, and the obtained data is stored for the customer. The signal processing unit 60 provides measurement data or calculation processing data from a sensor that has been assigned an ID that is only associated with a company (customer) authenticated by a known authentication mechanism (not illustrated) in the service providing unit 80, in accordance with a request from the customer.

In step S15, the analysis unit 70 calculates an index that clearly indicates a correlation among pieces of calculation processing data that have been stored in the memory (not illustrated) in the signal processing unit 60, as described above, or performs data analysis 72 on the pieces of calculation processing data, for example, with the Multivariate Statistical Process Control (MSPC), so as to obtain the life of a plant or a device, and provides an analysis result to the external user 90 who desires to be provided with the analysis result.

In step S16, the service providing unit 80 identifies, via the known authentication mechanism (not illustrated), a request for the measurement data that has been issued from the external user 90, and provides processing data of the signal processing unit 60 and/or analysis data of the analysis unit 70 to the external user 90 in accordance with a contract with the external user 90.

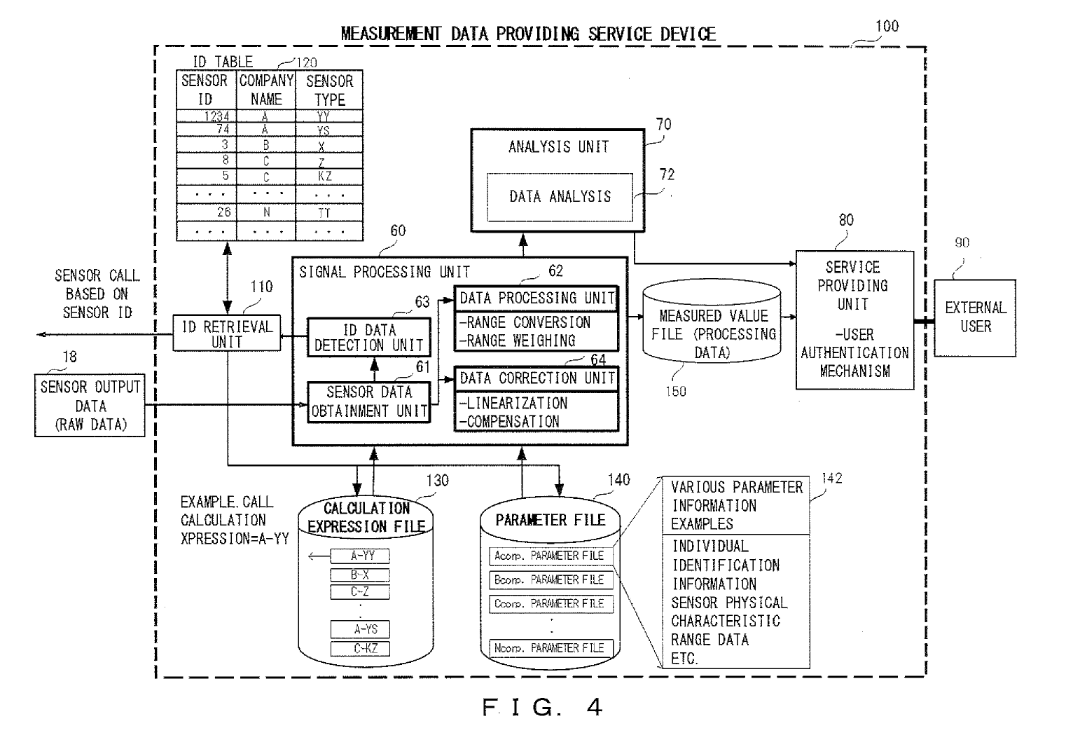

FIG. 4 illustrates content of respective components in a measurement data providing service device according to the embodiment of the present invention. In FIG. 4, the measurement data providing service device 100 receives the measurement data (raw data) 18 that has been transmitted via the network 40 of the communication provider and the LAN 50, as illustrated in FIG. 2, by means of a sensor data obtaining unit 61, extracts a sensor ID associated with received sensor output data, and transmits the extracted sensor ID to an ID data detection unit 63.

The ID data detection unit 63 transmits the detected ID data to an ID retrieval unit 110, and the ID retrieval unit 110 retrieves an ID table 120, and extracts a company name and a sensor type by using the sensor ID as a key. As illustrated in FIG. 4, the ID assigned to a sensor is configured of a serial number. The ID retrieval unit 110 refers to a calculation expression file 130 and a parameter file 140 on the basis of the extracted company name and sensor type, and transmits data obtained by referring to the calculation expression file 130 and the parameter file 140 to a data processing unit 62 and/or a data correction unit 64 in the signal processing unit 60.

The data processing unit 62 and/or the data correction unit 64 in the signal processing unit 60 performs data processing and/or data correction conforming to a company specification on the raw data received by the sensor data obtaining unit 61 on the basis of the data obtained by referring to the calculation expression file 130 and the parameter file 140. A result of the data processing and/or the data correction is output from the signal processing unit 60 to a measured value file 150.

Processing content in the data processing unit 62 and the data correction unit 64 described above are briefly described below.

In the data processing unit 62, conversion processing such as range conversion or range weighting is performed. In the data correction unit 64, correction processing such as linearization or compensation is performed.

The result of the data processing and/or the data correction is also provided from the signal processing unit 60 to the analysis unit 70, the data analysis 72 is performed in the analysis unit 70, and an analysis result is stored in the analysis unit 70, although this is not illustrated.

The result of the data processing and/or the data correction that has been stored in the measured value file 150, and, if the external user 90 desires, the result of the data analysis 72 are output to the service providing unit 80, and are provided from the service providing unit 80 to the external user 90.

The parameter file 140 includes parameter files for respective companies A to N, as illustrated. As an example, sensor individual identification information, a sensor physical characteristic, range data, and the like are stored as various pieces of parameter information 142 for company A.

In the calculation expression file 130, calculation expressions for respective companies and respective types have been registered, and an example is illustrated in which a calculation expression for a sensor of type YY of company A is called.

In FIG. 4, information that has been registered in the calculation expression file 130 and the parameter file 140 is merely exemplary, and it goes without saying that the information is not limited to this.

In FIG. 2, access to sensors is not illustrated, but in FIG. 4, the ID retrieval unit 110 refers to the ID table 120 at a required timing, extracts IDs of sensors to be accessed, and accesses sensors 11-16 having sensor IDs that have been extracted via the network 40 of the communication provider, the relay unit 30, and the conversion communication unit 20.

FIG. 4 illustrates an example in which a configuration of the signal processing unit 60 is shared, but signal processing units may be prepared for respective companies when the number of companies is not so large. When signal processing units are prepared for respective companies, a time needed to refer to the parameter file 140 and the calculation expression file 130 can be reduced, and therefore a processing time is efficiently reduced. However, when the number of companies is quite large, the number of signal processing units increases, and the addition of signal processing units may become a bottleneck.

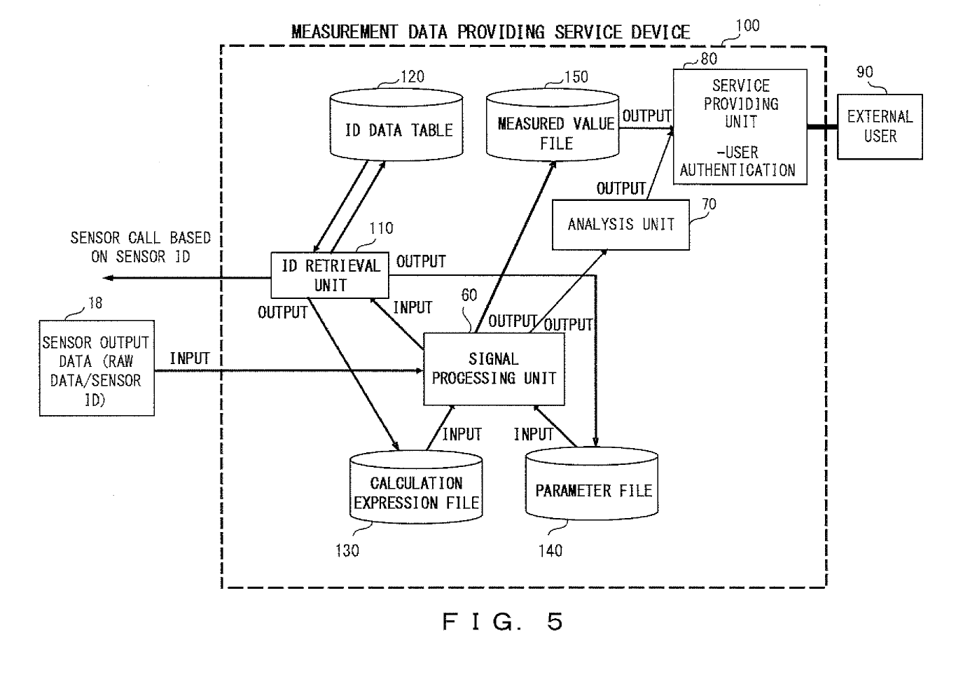

FIG. 5 illustrates a relationship among respective components in a measurement data providing service device according to the embodiment of the present invention. Components in FIG. 5 are basically the same as those in FIG. 4, but FIG. 5 is different from FIG. 4 in that “input” and “output” between the components are depicted with an arrow, and this allows a flow of information and a control flow to be easily understood. Respective pieces of content of the components in FIG. 5 are omitted here because the pieces of content have been described with reference to FIG. 4.

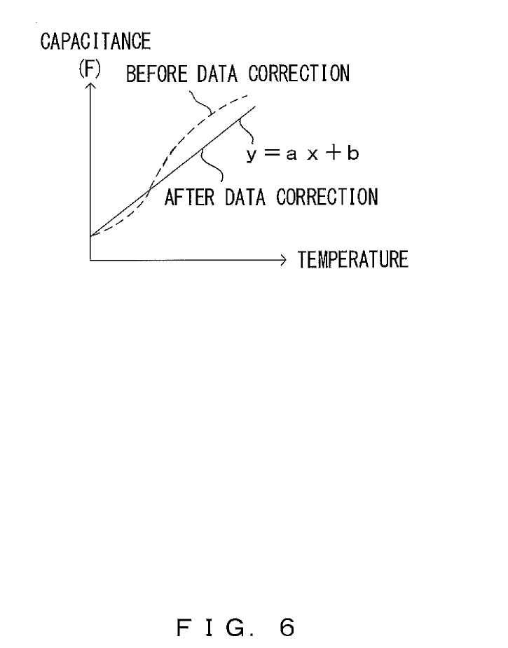

FIG. 6 illustrates an example explaining data processing in a data correction unit of a signal processing unit according to the present invention. In FIG. 6, a relationship between temperature and capacitance in a sensor mounted at the site may have a characteristic illustrated with a broken line due to the influence of production variations or the like. In a case in which measurement data having the characteristic illustrated with a broken line in FIG. 6 is obtained by a sensor mounted at the site, when the measurement data is faithfully reproduced without any changes by means of the signal processing unit 60 illustrated in FIG. 4, values on the broken line are merely obtained. The values on the broken line cannot be provided to the external user 90 without any changes, and therefore the values need to be corrected. In view of this, the data correction unit 64 in the signal processing unit 60 performs linearization on data before the correction on the broken line so as to be data after the correction illustrated with a solid line, and thus the processed data can be provided to the external user 90 as desired data.

### INDUSTRIAL APPLICABILITY

The present invention describes an example in which sensor equipment in a sensor network is minimized, raw data is merely transmitted from a sensor, a central measurement data providing service device performs signal processing on the raw data, and measurement data is provided to an external user. However, when the measurement data providing service device is constructed on a cloud, a global sensor network service can be provided.

1. A measurement data providing service system in which sensors are provided at the site, the sensors being assigned IDs for respective companies and respective types, or being assigned sequentially numbered IDs and forming a set with a table that identifies the respective companies and the respective types, a physical quantity to be measured is sensed by the sensor and is converted into a digital value, the converted digital value is transmitted as raw data via a network to a central measurement data providing service device, the measurement data providing service device performs signal processing on the raw data so as to be a significant measurement data value, and the significant measurement data value is provided to a user,
wherein the measurement data providing service device includes:
an ID data table that stores company names and type names that correspond to the IDs assigned to the sensors;
an ID retrieval unit that reads a prescribed ID from the ID data table, accesses the sensor associated with the ID via the network, and collects measurement data;
a signal processing unit that reads the ID from the measurement data transmitted from the sensor, searches the ID data table via the ID retrieval unit by using the read ID as a key, reads a parameter and a calculation expression associated with the ID from a parameter file and a calculation expression file, and performs signal processing;
a measured value file that stores measurement data significant in an industrial field, the measurement data being obtained by performing signal processing; and
a service providing unit that provides, to an external user, the measurement data significant in the industrial field, the measurement data being stored in the measured value file.

2. The measurement data providing service system according to claim 1, further comprising:
a relay unit that relays the raw data to the network, wherein
the relay unit includes:
a plurality of wireless reception units that each wirelessly receive the sensed raw data that has been converted into the digital value;
a concentrator that aggregates and outputs data of the plurality of wireless reception units; and
a portable communication module that receives the data output from the concentrator, and transmits the data to the network.

3. The measurement data providing service system according to claim 1, wherein
the signal processing unit performs at least one process or more of range conversion, range weighting, linearization, and compensation on the basis of content stored in the parameter file and the calculation expression file so as to conform to a specification of the external user.

4. The measurement data providing service system according to claim 3, wherein
the signal processing unit is provided so as to correspond to each of the companies.

5. The measurement data providing service system according to claim 4, wherein
the signal processing unit collectively performs signal processing on pieces of measurement raw data from sensors of the same company having different IDs.

6. The measurement data providing service system according to claim 3, wherein
the parameters associated with the IDs are provided in the parameter file so as to correspond to the respective companies and the respective types, or so as to have the sequentially numbered IDs and to correspond to the respective companies and the respective types by using the table.

7. The measurement data providing service system according to claim 2, wherein
the parameters associated with the IDs are provided in the parameter file so as to correspond to the respective companies and the respective types, or so as to have the sequentially numbered IDs and to correspond to the respective companies and the respective types by using the table.

8. The measurement data providing service system according to claim 1, wherein
the parameters associated with the IDs are provided in the parameter file so as to correspond to the respective companies and the respective types, or so as to have the sequentially numbered IDs and to correspond to the respective companies and the respective types by using the table.

9. The measurement data providing service system according to claim 6, wherein
the ID assigned to the sensor is configured of a serial number.

10. The measurement data providing service system according to claim 5, wherein
the ID assigned to the sensor is configured of a serial number.

11. The measurement data providing service system according to claim 4, wherein
the ID assigned to the sensor is configured of a serial number.

12. The measurement data providing service system according to claim 3, wherein
the ID assigned to the sensor is configured of a serial number.

13. The measurement data providing service system according to claim 2, wherein
the ID assigned to the sensor is configured of a serial number.

14. The measurement data providing service system according to claim 1, wherein
the ID assigned to the sensor is configured of a serial number.

15. The measurement data providing service system according to claim 3, wherein
the compensation in the signal processing unit performs correction to significant measured value data that conforms to a specification of the user's company by performing compensation for a change in temperature.

16. The measurement data providing service system according to claim 3, wherein
the range weighing in the signal processing unit performs data correction so as to obtain a range that conforms to a specification of the user's company by changing weighing of the range.

17. The measurement data providing service system according to claim 3, wherein
the linearization in the signal processing unit performs correction to measurement data having a linear characteristic by linearizing measurement data having a non-linear characteristic so as to obtain significant measured value data that conforms to a specification of the user's company.

18. The measurement data providing service system according to claim 1, wherein
the measurement data providing service device includes an analysis unit that receives data processed by the signal processing unit, and that performs data analysis and diagnosis.

19. The measurement data providing service system according to claim 18, wherein
the service providing unit includes an authentication mechanism that confirms genuineness of the external user, and provides the measurement data and/or analysis data significant in the industrial field to the external user for which the genuineness has been confirmed.

20. The measurement data providing service system according to claim 1, wherein
the service providing unit includes an authentication mechanism that confirms genuineness of the external user, and provides the measurement data and/or analysis data significant in the industrial field to the external user for which the genuineness has been confirmed.
